(19) United States
(12) Patent Application Publication
(10) Pub. No.: US 2009/0064836 A1
(43) Pub. Date: Mar. 12, 2009

(54) QUICKLY ASSEMBLED AND DISASSEMBLED PROTECTIVE COVER FOR A TABLE SAWING MACHINE

(76) Inventor: Bor-Yann CHUANG, Taiping City (TW)

Correspondence Address: SINORICA, LLC, 528 FALLSGROVE DRIVE, ROCKVILLE, MD, 20850, US

(21) Appl. No.: 11/852,634

(22) Filed: Sep. 10, 2007

(51) Int. Cl. B27G 19/00; B26D 7/22

(52) U.S. Cl. 83/478; 269/84; 83/860

(57) ABSTRACT

A quickly assembled and disassembled protective cover for a table sawing machine is pivotally assembled on a cover plate having one end secured on an assembly base of a quick disassembling device. The assembly base is bored with a positioning hole for a positioning pin to be axially inserted therein. When pushed or pulled to shift axially, the positioning pin can be inserted and positioned in or separated from a through hole of a chopper plate, and the positioning pin is fixed in position by a positioning element. By so designing, the assembly base can be quickly assembled on or disassembled from the chopper plate, achieving effect of quick assembly and disassembly of the protective cover.

### BACKGROUND OF THE INVENTION

1. Field of the Invention

This invention relates to a protective cover of a table sawing machine, particularly to one able to be quickly assembled on or disassembled from a chopper plate.

2. Description of the Prior Art

A conventional protective cover unit 10 for a table sawing machine is provided thereon with a cover plate 11 disposed with a quick disassembling device 20 assembled on a chopper plate 12. The quick disassembling device 20 is composed of a first shaft bushing 21, a second shaft bushing 22, a nut 23, a shaft pin 24, a press member 25 and an elastic member 26. The cover plate 11 has its opposite sides respectively provided with a lug 112 with a lug hole 111 and the chopper plate 12 is bored with a pin hole 121 at a location corresponding to the lug hole 111, and the quick disassembling device 20 is assembled in the lug hole 111 and the pin hole 121. The shaft pin 24 is fitted in the pin hole 121 of the chopper plate 12 and the press member 25 can be pressed to push the shaft pin 24 to shift and separate from the pin hole 121 of the chopper plate 12, letting both the cover plate 11 and the quick disassembling device 20 disengaged from the chopper plate 12. However, the conventional quick disassembling device 20 is composed of too many components and it is complicated in assembling. In addition, the extent of relative displacement between the shaft pin 24 and the press member 25 must be very accurate to match with the end center of the chopper plate 12; otherwise the shaft pin 24 cannot be smoothly fitted in or separated from the pin hole 121 of the chopper plate 12, disabling the protective cover unit 10 to be quickly assembled on or disassembled from the chopper plate 12.

### SUMMARY OF THE INVENTION

This invention is devised to offer a quickly assembled and disassembled protective cover for a table sawing machine. The protective cover is pivotally assembled on a cover plate having one end secured on an assembly base of a quick disassembling device. The assembly base is bored with a positioning hole for a positioning member of a positioning pin to be inserted therein. When pushed to shift axially, the positioning pin will be inserted in a through hole of a chopper plate and fixed in position by a positioning member, thus quickly assembling the protective cover on the chopper plate. When pulled to shift axially, the positioning pin will recover its original position and have its positioning member moved away from the through hole of the chopper plate to let the assembly base separated from the chopper plate, thus quickly disassembling the protective cover from the chopper plate.

### BRIEF DESCRIPTION OF DRAWINGS

This invention will be better understood by referring to the accompanying drawings, wherein:

FIG. 1 is a cross-sectional view of a conventional protective cover unit for a table sawing machine;

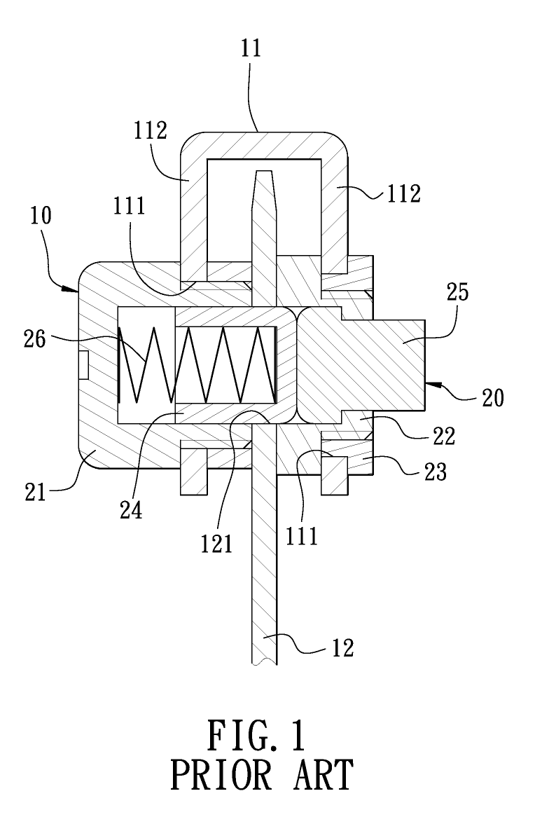

FIG. 2 is a partial exploded perspective view of a first preferred embodiment of a quickly assembled and disassembled protective cover for a table sawing machine in the present invention;

FIG. 3 is a cross-sectional view of the first preferred embodiment of the quickly assembled and disassembled protective cover for a table sawing machine in the present invention;

FIG. 4 is a cross-sectional view of the first preferred embodiment of the quickly assembled and disassembled protective cover in an operating condition in the present invention; and

FIG. 5 is a cross-sectional view of a second preferred embodiment of a quickly assembled and disassembled protective cover for a table sawing machine.

### DETAILED DESCRIPTION OF THE PREFERRED EMBODIMENT

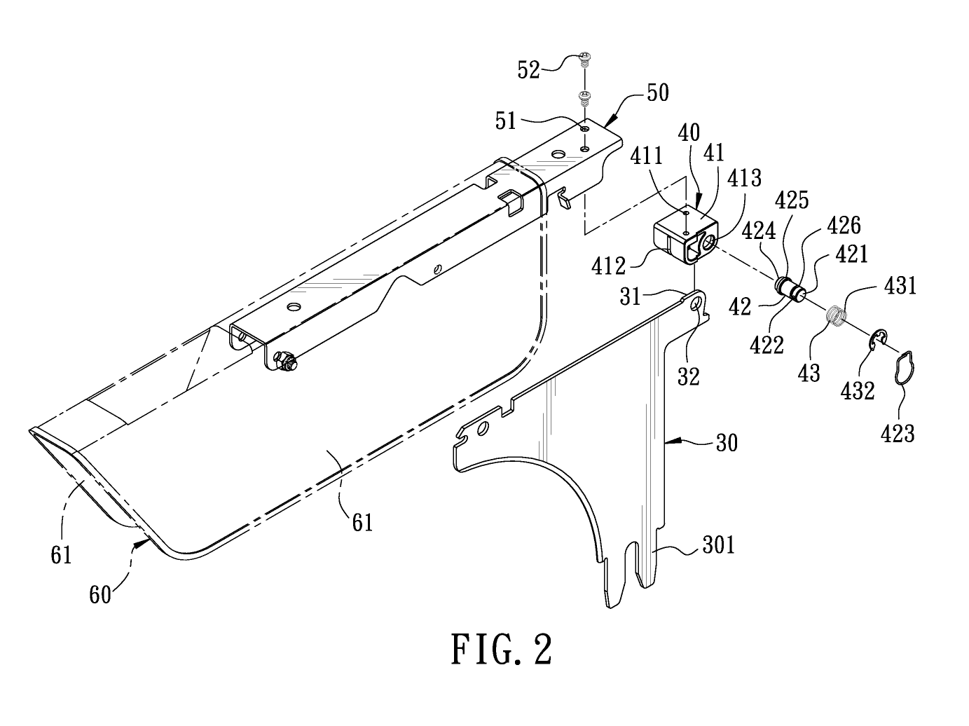

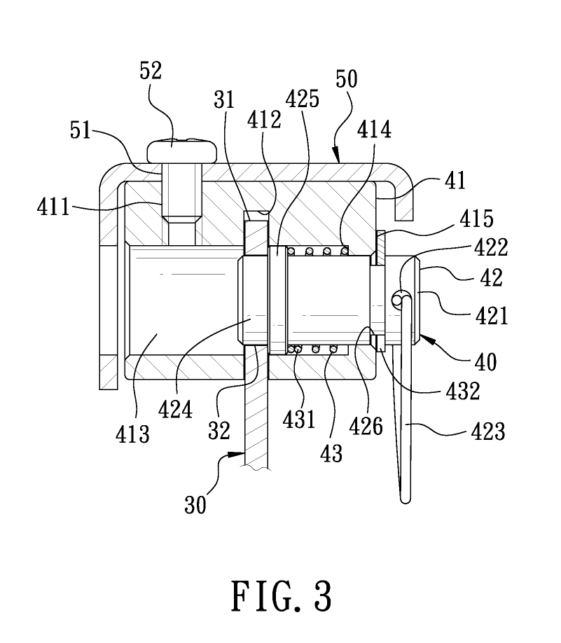

A first preferred embodiment of a quickly assembled and disassembled protective cover for a table sawing machine in the present invention, as shown in FIGS. 2 and 3, includes a copper plate 30, a quick disassembling unit 40, a cover plate 50 and a protective cover 60 combined together.

The chopper plate 30 has its lower portion provided with a fixing end 301 to be secured on a machine body of a table sawing machine (not shown) and its upper portion provided with a combining end 31 having one side bored with a through hole 32.

The quick disassembling unit 40 is composed of an assembly base 41, a positioning pin 42 and a positioning member 43.

The assembly base 41 has its topside vertically bored with two threaded holes 411 positioned diagonally and its central side vertically bored with an insert slot 412 to be combined with the combining end 31 of the chopper plate 30. Further, the assembly base 41 is axially bored with a positioning hole 413 intersected vertically with the insert slot 412 and having its front end formed with a comparatively small diameter, letting the inside and the outside of the positioning hole 413 respectively formed with an inner wall 414 and an outer wall 415.

The positioning pin 42 to be inserted in the positioning hole 413 of the assembly base 41 has its front end disposed with an operating member 421 diametrically bored with a hole 422 at a location near its outer end for a pull ring 423 to be clasped therein. The positioning pin 42 has another side, opposite to the operating member 421, formed with a positioning member 424 annularly fixed thereon with a stop member 425 at a location near its inner end and annularly bored with a positioning groove 426 at a location between the stop flange 425 and the operating member 421. The operating member 421 of the positioning pin 42 can be a bulging grip formed integrally or a toothed ring having embossing formed on its circumference for facilitating holding and operating.

The positioning member 43 is a spring 431 to be fitted around a circumference between the stop flange 425 and the positioning groove 426 of the positioning pin 42, and a C-shaped clasp 432 is clasped in the positioning groove 426, letting the opposite ends of the spring 431 respectively push against the stop member 425 and the inner wall 414 of the positioning hole 413 of the assembly base 41 and letting the C-shaped clasp 432 resist on the outer wall 415 of positioning hole 413.

The cover plate 50 has one end vertically bored with two insert holes 51 arranged diagonally and corresponding to the two threaded holes 411 of the assembly base 41. The cover plate 50 is fixedly assembled on the assembly base 41 by means of two fastening members 52 such as screws engaging with both the insert holes 51 and the threaded holes 411.

The protective cover 60 to be pivotally assembled on the cover plate has its opposite sides respectively extended downward and formed with a covering member 61.

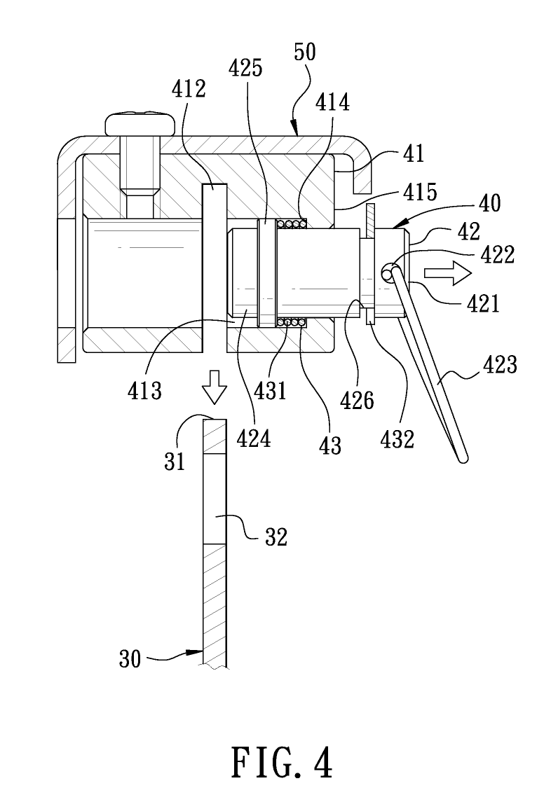

To assemble the protective cover 60 on the chopper plate 30, as shown in FIGS. 2, 3 and 4, firstly, the pull ring 423 is pulled to let the positioning pin 42 shift axially toward the front end of the positioning hole 413. Next, the insert slot 412 of the assembly base 41 is inserted on the combining end 31 of the chopper plate 30, letting the positioning hole 413 of the assembly base 41 aligned to the through hole 32 of the chopper plate 30. At this time, release pull force of the pull ring 423 to let the spring 431 move back to its original position by its restored elastic force to push the positioning member 424 of the positioning pin 42 to pass through the positioning hole 413 and be inserted in the through hole 32 of the chopper plate 30, letting the stop member 425 of the positioning pin 42 blocked and positioned at the outer end of the through hole 32 of the chopper plate 30, thus quickly assembling the protective cover 60 on the chopper plate 30.

On the contrary, to disassemble the protective cover 60 from the combining end 31 of the chopper plate 30, simply pull the pull ring 423 to let the positioning pin 42 shift axially toward the front end of the positioning hole 413 of the assembly base 41, with the positioning member 424 moved away from the through hole 32 of the chopper plate 30. Thus, the assembly base 41 can separate from the combining end 31 of the chopper plate 30, and the protective cover 60 can be quickly disassembled from the chopper plate 30.

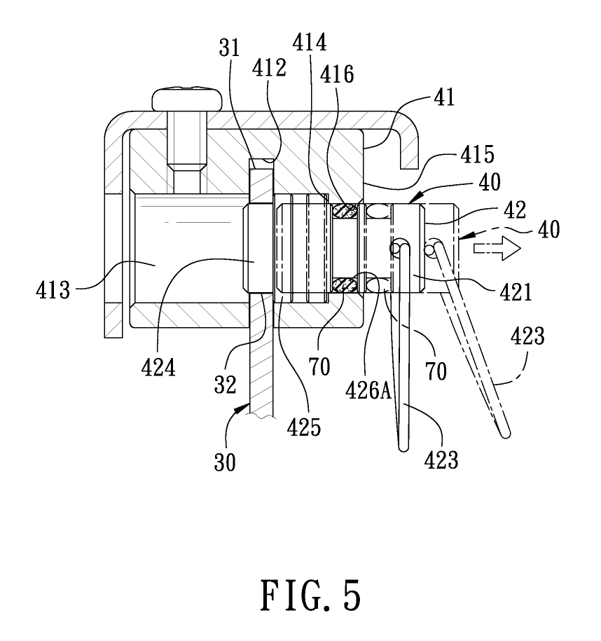

A second preferred embodiment of a quickly assembled and disassembled protective cover for a table sawing machine in the present invention, as shown in FIG. 5, has almost the same structure as that described in the first preferred embodiment, except that a positioning groove 426A of the positioning pin 42 is annularly provided between the stop flange 425 and the operating member 421, and the positioning member is an O-shaped ring 70 to be fitted in the positioning groove 426A. When the pull ring 423 is pulled to let the positioning pin 42 shift axially toward its front end, the positioning member 424 of the positioning pin 42 will be separated from the through hole 32 of the chopper plate 30. At this time, the O-shaped ring 70 is positioned at the outside of the outer wall 415 of the positioning hole 413, enabling the assembly base 41 to be quickly disengaged from the chopper plate 30. On the contrary, when the positioning pin 42 is pushed to move inward axially, the positioning member 424 will be inserted in the through hole 32 of the chopper plate 30, and the stop member 425 will be blocked at the outside of the through hole 32. At this time, the O-shaped ring 70 fitted in the positioning groove 426A of the positioning pin 42 will be tightly positioned on a circumference 416 between the inner and the outer wall 414 and 415 of the positioning hole 413 of the assembly base 41, thus quickly assembling the assembly base 41 on the chopper plate 30.

Specifically, the quick disassembling device of this invention is simple in structure and easy in handling, and the protective cover can be quickly assembled on or disassembled from the chopper plate only by inserting the positioning member of the positioning pin into the through hole of the chopper plate and securing the positioning pin in position by the positioning member.

While the preferred embodiments of the invention have been described above, it will be recognized and understood that various modifications may be made therein and the appended claims are intended to cover all such modifications that may fall within the spirit and scope of the invention.

I claim:

1. A quickly assembled and disassembled protective cover for a table sawing machine comprising:
a chopper plate having one end of its upper side bored with a through hole;
a quick disassembly device provided with an assembly base to be optionally assembled at an upper portion of said chopper plate, said assembly base bored with a positioning hole corresponding to said through hole of said chopper plate, said assembly base having its central side vertically bored with an insert slot to be engaged with said chopper plate, said positioning hole intersected vertically with said insert slot, said quick disassembly device further provided with a positioning pin, said positioning pin having one end formed with an operating member and another end formed with a positioning member, said positioning member axially inserted and positioned in said positioning hole of said assembly base, said operating member of said positioning pin extended out of said positioning hole of said assembly base, a positioning element assembled at a proper location of said positioning pin, said positioning member of said positioning pin inserted in said through hole of said chopper plate when said positioning pin is pushed to shift axially, said positioning pin secured in said positioning hole by said positioning member, thus said protective cover quickly assembled on said chopper plate, said positioning member of said positioning pin moved away from said through hole of said chopper plate to let said assembly base separated from said chopper plate, thus to quickly disassemble said protective cover from said chopper plate;
a cover plate having one end secured on said assembly base; and
a protective cover pivotally mounted on said cover plate, said protective cover having its opposite sides respectively extended downward and formed with a covering member.

2. The quickly assembled and disassembled protective cover for a table sawing machine as claimed in claim 1, wherein said positioning member of said positioning pin is formed with a stop flange at a location near its inner end, and said positioning member is a spring, said spring fitted around a circumference between said stop flange and a positioning groove of said positioning pin, said spring having its opposite ends respectively pushing against said stop flange of said positioning pin and resisting on an inner wall at one end of said positioning hole of said assembly base, a C-shaped clasp engaged in said positioning groove of said positioning pin and pressed on an outer wall of said positioning hole of said assembly base, said positioning pin disengaged from said through hole of said chopper plate when said positioning pin is pulled to shift axially, said positioning member of said positioning pin inserted in said through hole of said chopper plate when pull force is released and said positioning pin is pushed to recover its original position by restored elastic force of said spring.

3. The quickly assembled and disassembled protective cover for a table sawing machine as claimed in claim 2, wherein said operating member of said positioning pin is diametrically bored with a hole for a pull ring to be clasped therein.

4. The quickly assembled and disassembled protective cover for a table sawing machine as claimed in claim 2, wherein said operating member of said positioning pin is a bulging grip formed integrally.

5. The quickly assembled and disassembled protective cover for a table sawing machine as claimed in claim 2, wherein said operating member of said positioning pin is a toothed ring having its circumference formed with embossed patterns.

6. The quickly assembled and disassembled protective cover for a table sawing machine as claimed in claim 1, wherein a positioning groove is provided between said stop flange and said operating member of said positioning pin and said positioning member is an O-shaped ring, said O-shaped ring fitted in said positioning groove tightly pressed on or disengaged from a circumference of said positioning hole of said assembly base.

7. The quickly assembled and disassembled protective cover for a table sawing machine as claimed in claim 6, wherein said operating member of said positioning pin is bored with a hole for a pull ring to be clasped therein.

8. The quickly assembled and disassembled protective cover for a table sawing machine as claimed in claim 6, wherein said operating member of said positioning pin is a protuberant grip formed integrally.

9. The quickly assembled and disassembled protective cover for a table sawing machine as claimed in claim 6, wherein said operating member of said positioning pin is a toothed ring having its circumference formed with embossed patterns.

10. The quickly assembled and disassembled protective cover for a table sawing machine as claimed in claim 1, wherein said assembly base of said quick disassembly device is vertically bored with two threaded holes arranged diagonally and said cover plate has one end vertically bored with two insert holes corresponding to said two threaded holes, said cover plate secured on said assembly base by means of two fastening members.
